(19) United States
(12) Patent Application Publication
(10) Pub. No.: US 2019/0073703 A1
(43) Pub. Date: Mar. 7, 2019

(54) METHODS AND SYSTEMS OF AN ONLINE VEHICLE SALE WEBSITE

(71) Applicant: SANDEEP Aggarwal, SAN JOSE, CA (US)

(72) Inventor: SANDEEP Aggarwal, SAN JOSE, CA (US)

(21) Appl. No.: 15/904,311

(22) Filed: Feb. 23, 2018

Related U.S. Application Data
(60) Provisional application No. 62/462,820, filed on Feb. 23, 2017.

(51) Int. Cl. G06Q 30/02; G06Q 30/06

(52) U.S. Cl. CPC G06Q 30/0283; G06Q 30/0627

(57) ABSTRACT

A computer-implemented method for managing the sale of a vehicle in an online used-vehicle marketplace includes the step of receiving a set of buying preferences for used vehicles of a dealer entity. The computer-implemented method includes the step of listing, on the online used-vehicle marketplace, a used vehicle for sale by a seller entity. The computer-implemented method includes the step of matching, with at least one server of the online used-vehicle marketplace, a set of seller's used vehicle attributes with the set of buying preferences for used vehicles of the dealer entity. The computer-implemented method includes the step of notifying the dealer entity, via an electronic message of the match.

### CROSS-REFERENCE TO RELATED APPLICATIONS

This application is a claims priority from U.S. Provisional Application No. 62/462,820, titled METHODS AND SYSTEMS OF AN ONLINE VEHICLE SALE WEBSITE and filed 23 Feb. 2017. This application is hereby incorporated by reference In its entirety.

### BACKGROUND

### 1. Field

This application relates generally to improvements to computerized methods of online vehicle sales websites.

### 2. Related Art

A used-vehicle dealer may wish to purchase used vehicles from sellers. The sellers can set the prices for the used vehicles to be offered to the used-vehicle dealer. The sellers may be motivated to sell the vehicles quickly. However, the sellers may not understand a proper pricing for the used vehicles to sell quickly. Accordingly, improvements to online used vehicle marketplaces are desired to automatically and algorithmically suggest ‘quick sale’ prices to sellers.

### SUMMARY OF INVENTION

A computer-implemented method for managing the sale of a vehicle in an online used-vehicle marketplace includes the step of receiving a set of buying preferences for used vehicles of a dealer entity. The computer-implemented method includes the step of listing, on the online used-vehicle marketplace, a used vehicle for sale by a seller entity. The computer-implemented method includes the step of matching, with at least one server of the online used-vehicle marketplace, a set of seller's used vehicle attributes with the set of buying preferences for used vehicles of the dealer entity. The computer-implemented method includes the step of notifying the dealer entity, via an electronic message of the match.

### BRIEF DESCRIPTION OF THE DRAWINGS

FIG. 1 illustrates an example system of an online vehicle marketplace, according to some embodiments.

FIG. 2 depicts an exemplary computing system that can be configured to perform any one of the processes provided herein.

FIG. 3 is a block diagram of a sample computing environment that can be utilized to implement various embodiments.

FIG. 4 illustrates an example process for managing the sale of a vehicle in an online used-vehicle marketplace, according to some embodiments.

FIG. 5 illustrates an example process for providing an online vehicle marketplace for a seller side, according to some embodiments.

FIG. 6 illustrates an example process for providing an online vehicle marketplace for buyer side, according to some embodiments.

The Figures described above are a representative set and are not an exhaustive with respect to embodying the invention.

### DESCRIPTION

Disclosed are a system, method, and article of manufacture for an online vehicle sale website. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application programming interface (API) can specify how software components of various systems interact with each other.

Cloud computing can involve deploying groups of remote servers and/or software networks that allow centralized data storage and online access to computer services or resources. These groups of remote serves and/or software networks can be a collection of remote computing services.

Geolocation can be the identification of the real-world geographic location of an object, such as a radar source, mobile phone or Internet-connected computer terminal. Geolocation may refer to the practice of assessing the location, or to the actual assessed location. Geolocation use of positioning systems and also determines a meaningful location (e.g. a street address), as well as, a set of geographic coordinates.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning.

Mobile device can include a handheld computing device that includes an operating system (OS), and can run various types of application software, known as apps. Example handheld devices can also be equipped with various context sensors (e.g. biosensors, physical environmental sensors, etc.), digital cameras, Wi-Fi, Bluetooth, and/or GPS capabilities. Mobile devices can allow connections to the Internet and/or other Bluetooth-capable devices, such as an automobile, a wearable computing system and/or a microphone headset. Exemplary mobile devices can include smart phones, tablet computers, optical head-mounted display (OHMD) (e.g. Google Glass®), virtual reality head-mounted display, smart watches, other wearable computing systems, etc.

### EXAMPLE EMBODIMENTS

In some embodiments, a C2B (customer to business) and/or B2B (business to business) marketplace for vehicles (e.g. automobiles, motorcycles, boats, airplanes, etc.) is provided. The market a user to sell a vehicle at a faster rate. For example, a person may desire to optimize time over a sales price. Accordingly, a pricing algorithm is provided such that the vehicles is sold at a price lesser than the market value but still ensures a lucrative transition sale to a dealer that purchases said vehicle. In pricing algorithm provides a price that encourages a dealer to purchase a vehicle in a short turn around.

A use wishing to sell a vehicle in a short turnaround time can list the vehicle in in the online vehicle marketplace. The user can provide various vehicle details such as, inter alia: the make, model, year of a manufacture, kilometers/miles driven, intended price of sale and/or intended period to sell. A pricing algorithm utilized the price of the vehicle from an automated online vehicle appraisal service (e.g. Orange book value, etc.) price of similar vehicles sold on online vehicle marketplace platform and prices of similar vehicles listed on online vehicle marketplace's platform. Similar vehicles can be vehicles with the same make, model, year of manufacture and trim. In addition to this, a user willing to sell the vehicle, can also select the intended period to sell. The shorter the intended period to sell, the lesser can be the price at which the user can sell. Various historical vehicle sale's data with the used-vehicle dealers willing to participate in the online vehicle marketplace to arrive at the kind of discount in price that they are expecting to purchase the vehicle from online vehicle marketplace for their transition sale based on intended period to sell. It is noted that, the shorter the time to purchase, lesser will be the price offered. In one example, the online vehicle marketplace can discount the price by 8% for a 7-day intended period to sell, 6% for a 14-day intended period to sell and 4% for a 21-day intended period to sell.

For example, if a vehicle is listed at Rs. 10,00,000 on the online vehicle marketplace, with a 7-day intended period to sell, the vehicle's price will be Rs. 9,20,000, with a 14-day intended period to sell, the price of the vehicle will be 9,40,000 and with a 21-day intended period to sell, the price of the vehicle will be 9,60,000. While indian rupees are used as an example herein, other national currencies can be also be utilized in other example embodiments.

### Example Computer Architecture and Systems

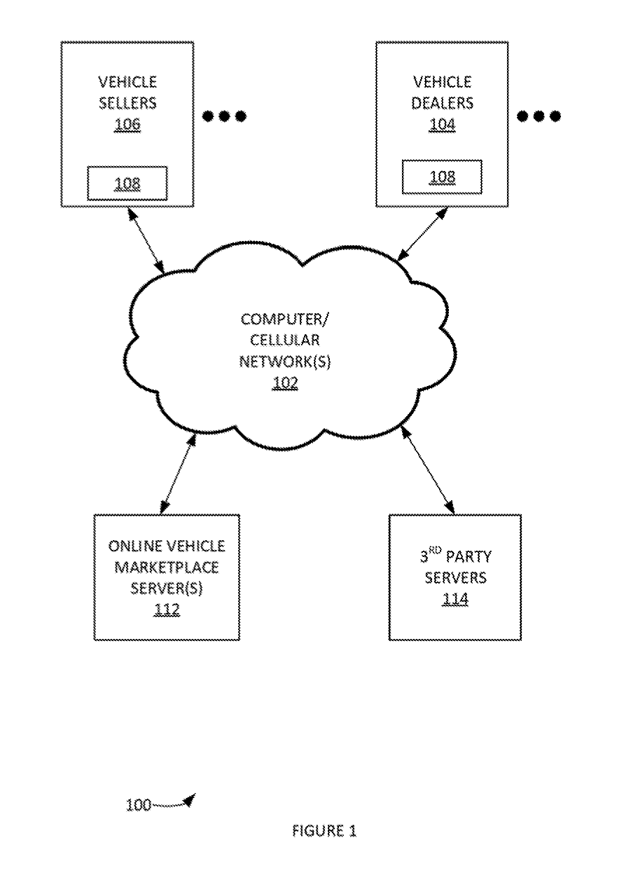

FIG. 1 illustrates an example system 100 for managing an online vehicle marketplace, according to some embodiments. System 100 can include various computer and/or cellular data networks 100. Networks 100 can include the Internet, text messaging networks (e.g. short messaging service (SMS) networks, multimedia messaging service (MMS) networks, proprietary messaging networks, instant messaging service networks, email systems, etc. Networks 100 can be used to communicate messages and/or other information from the various entities of system 100.

System 100 can include vehicle sellers computing devices 106 and vehicle dealers computing devices 104, etc. Online vehicle marketplace application 108 can enables user (e.g. sellers, purchasers, dealers, technicians, etc.) to implement various aspects of the processes and methods provided herein. For example, sellers can use online vehicle marketplace application 108 list vehicles, sell vehicles, order vehicle inspections, pay for vehicle inspection services, etc. Dealers can use online vehicle marketplace application 108 to list vehicles, purchase vehicles, order vehicle inspections, pay for vehicle inspection services, etc.

System 100 can include online vehicle market place server(s) 112. Online vehicle market place server(s) 112 can implement the various processes and methods provided herein. Online vehicle market place server(s) 112 implement the server-side parts of processes 400-800. System 100 can include online vehicle market place server(s) 112 include web servers, geo-location systems, email servers, IM servers, database management systems, search engines, electronic payment servers, member management systems, administration systems, machine-learning systems, ranking systems, optimizations systems, etc. Third-party services server (s) 114 can provided various third-party services (e.g. mapping services, vehicle valuation databases/services, etc.).

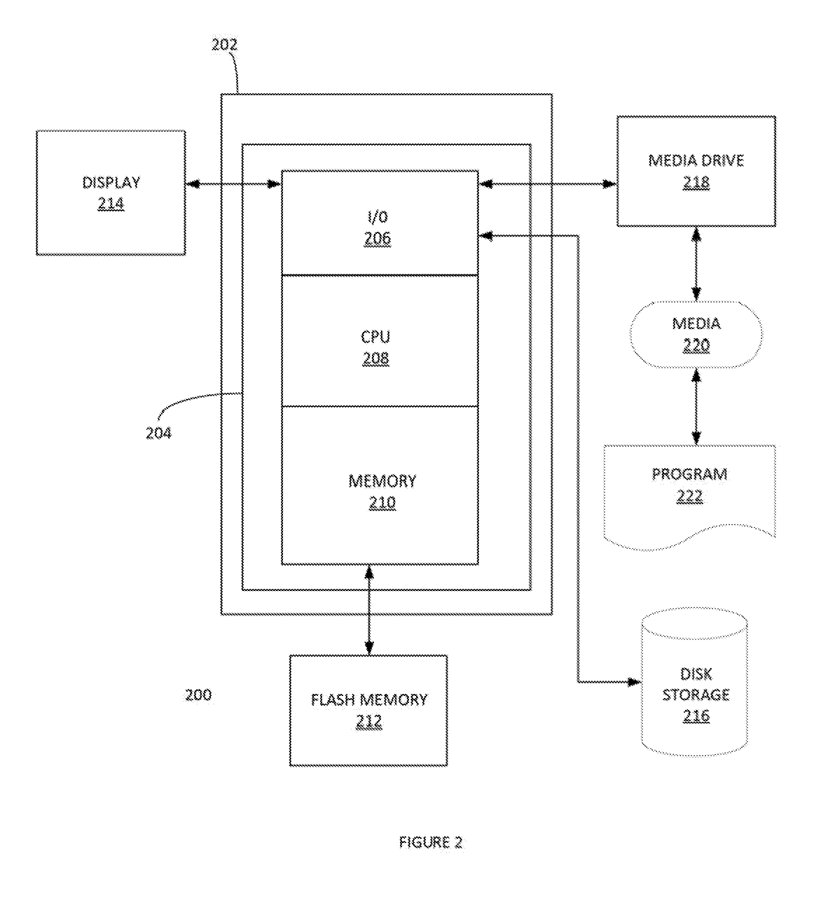

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, internet connection, etc.). However, computing system 200 may include circuitry or other specialized hardware for carrying out some or all aspects of the processes. In some operational settings, computing system 200 may be configured as a system that includes one or more units, each of which is configured to carry out some aspects of the processes either in software, hardware, or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown), a disk storage unit 216, and a media drive unit 218. The media drive unit 218 can read/write a computer-readable medium 220, which can contain programs 222 and/or data. Computing system 200 can include a web browser. Moreover, it is noted that computing system 200 can be configured to include additional systems in order to fulfill various functionalities. Computing system 200 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

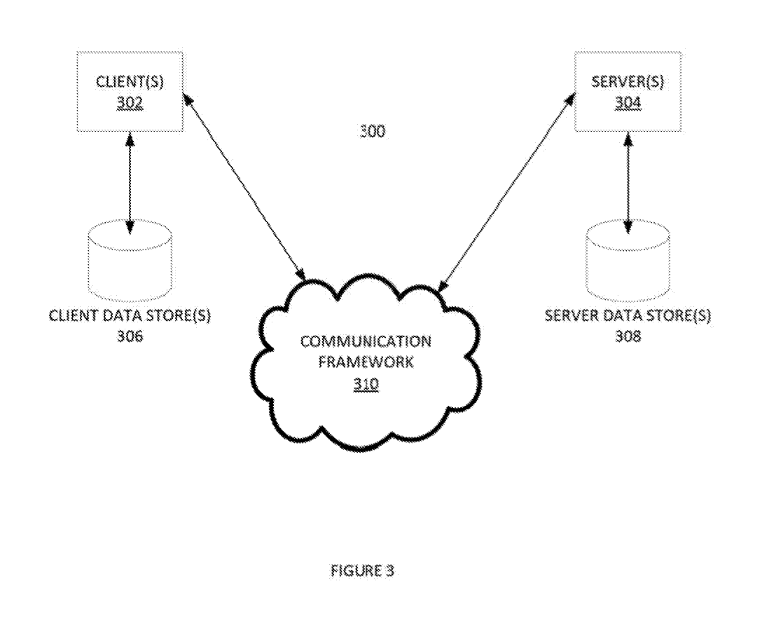

FIG. 3 is a block diagram of a sample computing environment 300 that can be utilized to implement various embodiments. The system 300 further illustrates a system that includes one or more client(s) 302. The client(s) 302 can be hardware and/or software (e.g., threads, processes, computing devices). The system 300 also includes one or more server(s) 304. The server(s) 304 can also be hardware and/or software (e.g., threads, processes, computing devices). One possible communication between a client 302 and a server 304 may be in the form of a data packet adapted to be transmitted between two or more computer processes. The system 300 includes a communication framework 310 that can be employed to facilitate communications between the client(s) 302 and the server(s) 304. The client(s) 302 are connected to one or more client data store(s) 306 that can be employed to store information local to the client(s) 302. Similarly, the server(s) 304 are connected to one or more server data store(s) 308 that can be employed to store information local to the server(s) 304. In some embodiments, system 300 can instead be a collection of remote computing services constituting a cloud-computing platform.

### Exemplary Methods

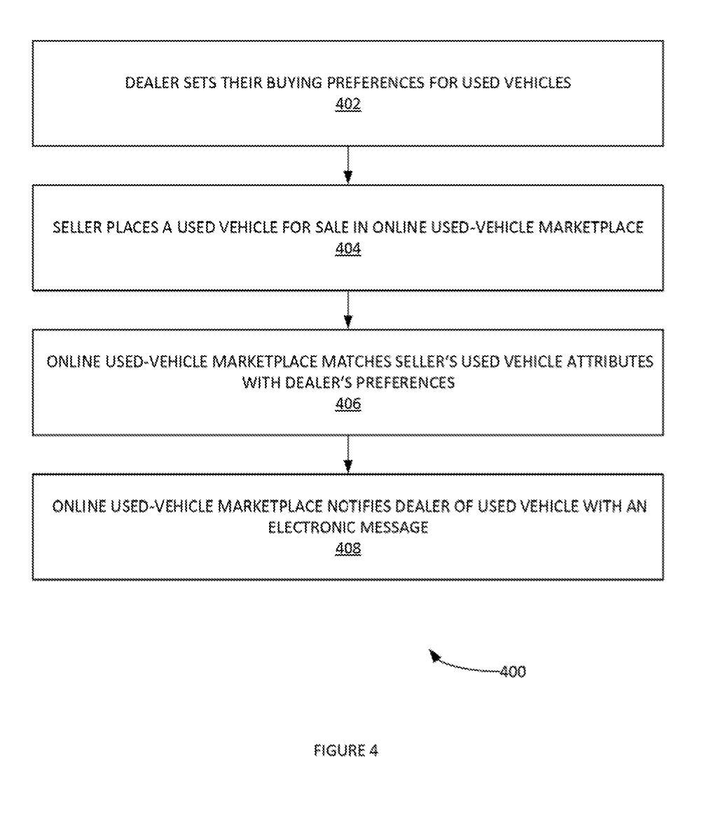

FIG. 4 illustrates an example process 400 for managing the sale of a vehicle in an online used-vehicle marketplace, according to some embodiments. In step 402, a dealer can set their buying preferences for used vehicles. In step 404, the seller places a used vehicle for sale in online used-vehicle marketplace.

In step 406, the online used-vehicle marketplace matches seller's used vehicle attributes with dealer's preferences. Process 400 can use various matching algorithms.

In step 408, the online used-vehicle marketplace notifies dealer of used vehicle with an electronic message (e.g. emails, text messages, instant-messages, in-application push notifications, voice mails, etc.).

In one example, process 400 can include a vehicle pricing algorithm. The pricing algorithm can be set to provide selling prices that motivate a faster sale from a vehicle owner to a used-vehicle dealer. The used-vehicle dealer can set various buying preferences. Example buying preferences can be set by vehicle category, vehicle make, vehicle model, year of vehicle manufacture and vehicle trim level. In some examples, the location/geographic region a used-vehicle dealer is willing to purchase a used vehicle can also be set. The used-vehicle dealer can also set a price range for which they will purchase a used-vehicles can also be set in the buying preference.

In some examples, alerts and notifications can be triggered to the used-vehicle dealers based on their respective buying preferences. The alerts can be triggered using SMS, electronic mail and/or push notifications as and when vehicles corresponding to the buying preference gets listed on the online-vehicle marketplace. The notifications and alerts can be configured and customized by the dealers as per their requirement.

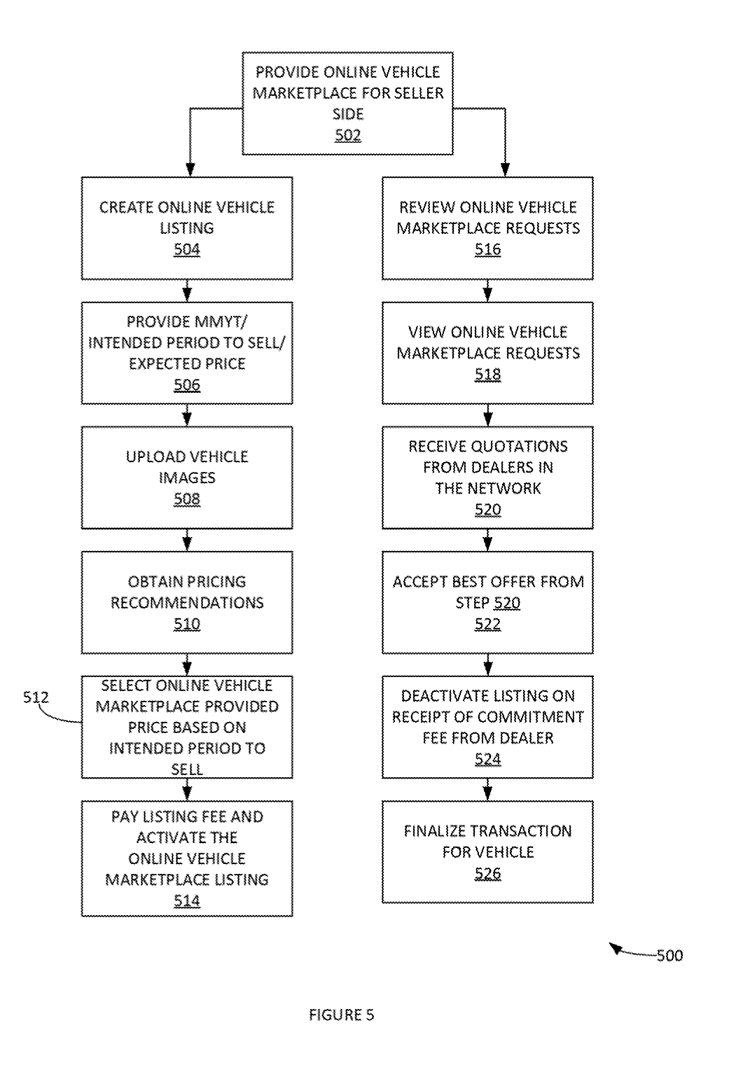

FIG. 5 illustrates an example process 500 for providing an online vehicle marketplace for a seller side, according to some embodiments. In step 502, process 500 can provide online vehicle marketplace for seller side. In step 504, process 500 can create online vehicle listing. In step 506, process 500 can provide MMYT/intended period to sell/expected price. In step 508, process 500 can upload vehicle images. In step 510, process 500 can obtain pricing recommendations. In step 512, process 500 can select online vehicle marketplace provided price based on intended period to sell. In step 514, process 500 can pay listing fee and activate the online vehicle marketplace listing. In step 516, process 500 can review online vehicle marketplace requests. In step 518, process 500 can view online vehicle marketplace requests. In step 520, process 500 can receive quotations from dealers in the network. In step 522, process 500 can accept best offer from step 520. In step 524, process 500 can deactivate listing on receipt of commitment fee from dealer. In step 526, process 500 can finalize transaction for vehicle.

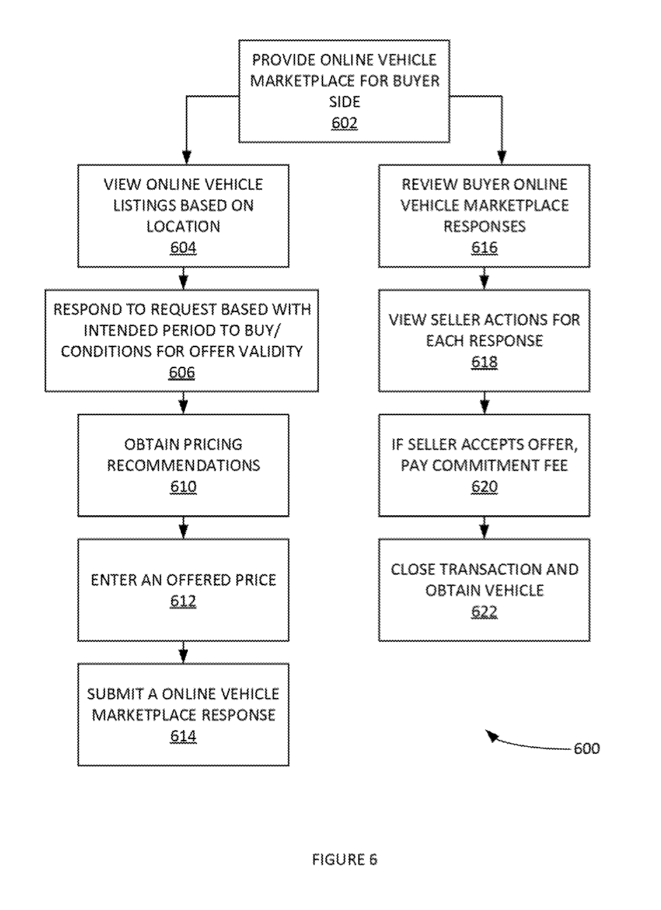

FIG. 6 illustrates an example process 600 for providing an online vehicle marketplace for buyer side, according to some embodiments. In step 602, process 600 provide online vehicle marketplace for buyer side. In step 604, process 600 view online vehicle listings based on location. In step 606, process 600 respond to request based with intended period to buy/conditions for offer validity. In step 608, process 600 obtain pricing recommendations. In step 610, process 600 enter an offered price. In step 612, process 600 submit an online vehicle marketplace response. In step 614, process 600 review buyer online vehicle marketplace responses. In step 616, process 600 view seller actions for each response. In step 618, process 600 if seller accepts offer, pay commitment fee. In step 620, process 600 close transaction and obtain vehicle.

Additional Material

There are several methods which may be used to select a proper sample size and/or use a given sample to make statements (within a range of accuracy determined by the sample size) about a specified population. These methods may include, for example:
1. Classical Statistics as, for example, in “Probability and Statistics for Engineers and Scientists” by R. E. Walpole and R. H. Myers, Prentice-Hall 1993; Chapter 8 and Chapter 9, where estimates of the mean and variance of the population are derived.
2. Bayesian Analysis as, for example, in “Bayesian Data Analysis” by A Gelman, 1. B. Carlin, H. S. Stern and D. B. Rubin, Chapman and Hall 1995; Chapter 7, where several sampling designs are discussed.
3. Artificial Intelligence techniques, or other such techniques as Expert Systems or Neural Networks as, for example, in “Expert Systems: Principles and Programming” by Giarratano and G. Riley, PWS Publishing 1994; Chapter 4, or “Practical Neural Networks Recipes in C++” by T. Masters, Academic Press 1993; Chapters 15, 16, 19 and 20, where population models are developed from acquired data samples.

It is noted that these statistical methodologies are for exemplary purposes and other statistical methodologies can be utilized and/or combined in various embodiments. These statistical methodologies can be utilized elsewhere (e.g. in process 100, other processes provided herein, etc.), in whole or in part, when appropriate as well.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computer-implemented method for managing the sale of a vehicle in an online used-vehicle marketplace comprising:
receiving a set of buying preferences for used vehicles of a dealer entity;
listing, on the online used-vehicle marketplace, a used vehicle for sale by a seller entity;
matching, with at least one server of the online used-vehicle marketplace, a set of seller's used vehicle attributes with the set of buying preferences for used vehicles of the dealer entity;
notifying the dealer entity, via an electronic message of the match.

2. The computer-implemented method of claim 1 further comprising:
providing a vehicle pricing algorithm that sets to a selling price of the used vehicle at a level that motivates a faster sale from the selling entity to the dealer entity.

3. The computer-implemented method of claim 2, wherein the set of buying preferences for used vehicles of the dealer entity comprises a vehicle category, a vehicle make, and a vehicle model.

4. The computer-implemented method of claim 3, wherein the set of buying preferences for used vehicles of the dealer entity comprises a year of vehicle manufacture and a vehicle trim level.

5. The computer-implemented method of claim 4, wherein the set of buying preferences for used vehicles of the dealer entity comprises a location/geographic region the dealer entity is willing to purchase from.

6. The computer-implemented method of claim 4, wherein the set of buying preferences for used vehicles of the dealer entity comprises a price range for which the dealer entity specifies.
